(19) United States
(12) Patent Application Publication
(10) Pub. No.: US 2015/0043084 A1
(43) Pub. Date: Feb. 12, 2015

(54) ILLUMINATED DISPLAY DEVICE CASE COMPRISING AN INTEGRATED OPTICAL FILM

(71) Applicant: 3M INNOVATIVE PROPERTIES COMPANY, St. Paul, MN (US)

(72) Inventors: Thomas M. Snyder, St. Paul, MN (US); Michelle L. Toy, North St. Paul, MN (US); Jeong-Wan Kim, Seoul (KR); Yongchan Ahn, Kyunggi-do (KR); You-Jung Oh, Seoul (KR); Edward L. Weaver, II, Milford, OH (US); Patrick E. Bisek, Rosemount, MN (US)

(21) Appl. No.: 14/342,808

(22) PCT Filed: Jan. 4, 2013
(86) PCT No.: PCT/US13/20210

§ 371 Date: Mar. 5, 2014

Related U.S. Application Data
(60) Provisional application No. 61/584,556, filed on Jan. 9, 2012.
(60) Provisional application No. 61/623,704, filed on Apr. 13, 2012.

(51) Int. Cl. G02B 27/30; G06F 1/18

(52) U.S. Cl. CPC G02B 27/30; G06F 1/182
USPC 359/641

(57) ABSTRACT

for receiving an illuminated display device such as a tablet are described. The cases comprise a (e.g. light-collimating) optical film integrated with the case. The illuminated display device is intended to be operated while contained within (rather than being removed from) the case. The illuminated display surface can be viewed through the (e.g. light-collimating) optical film when an illuminated display device is provided within the case.

### SUMMARY OF THE INVENTION

The cases described herein are generally suitable for receiving an illuminated display device. The cases comprise a (e.g. light-collimating) optical film integrated with the case. The illuminated display device is intended to be operated while contained within (rather than being removed from) the case. The illuminated display surface can be viewed through the (e.g. light-collimating) optical film when an illuminated display device is provided within the case.

In one embodiment, the case comprises a first panel having an interior surface comprising an attachment mechanism suitable for attaching an illuminated display device; and a second panel connected to the first panel along an edge; wherein the second panel comprises the (e.g. light-collimating) optical film. In some embodiments, the case folds open and closed along the edge that connects the first and second panel such that when closed the interior surface of the first panel is in a plane substantially parallel to the optical film prior to the case receiving an illuminated display device. The interior surface of the first panel is visible through the optical film prior to the case receiving an illuminated display device.

In yet another embodiment, a case is described comprising a first (e.g. back) panel having an interior surface comprising an attachment mechanism suitable for attaching an electronic display device; a second (e.g. front) panel connected to the back panel along an edge such that the case is foldable along the edge; and at least one additional panel disposed between the back and front panel wherein the additional panel comprises a (e.g. light-collimating) optical film. The front, back and additional panel may be bound along a common edge. In some embodiments, the front and back panel are bound along a common edge and the additional panel(s) are removably attached to the case.

In another embodiment, a case is described comprising a back panel; and a front panel comprising a (e.g. light-collimating) optical film connected to the first panel along two parallel edges forming a sleeve such that an interior surface of the back panel is visible through the optical film. The second panel may optionally be connected to the first panel along an orthogonal edge forming a pocket. When the back panel comprises an elastomeric material, the sleeve or pocket is typically slightly smaller than the illuminated display device such that the sleeve or pocket stretches when a device is inserted such that the optical film lies flush in contact with the illuminated display surface of the device.

In each of the embodiments described, the (e.g. light-collimating) optical film may be permanently integrated with the case such as by permanently bonding the optical film to the case or permanently bonding the optical film to a panel, the panel being permanently bonded to the case. When the optical film is permanently integrated with the case, the case is typically preassembled such that the case comprises the optical film.

Alternatively, the (e.g. light-collimating) optical film may be removably attached to the case or the optical film may be removably attached to a panel, the panel being permanently bonded to the case. When removably attached, the (e.g. light-collimating) optical film may be replaced without replacing the case. When the optical film is removably attached to the case, the case and optical film may be provided as separate parts of a case kit that may be subsequently assembled such that the optical film is integrated with the case. In some embodiments, the case and the optical film or the case and a panel comprising the optical film may comprise cooperating attachment mechanisms, such as a hook and loop fastener. In yet another embodiment, neither the case or optical film of the kit comprises attachment mechanisms. In this embodiment, the kit typically comprises a separate component for attachment, such as a double-faced pressure sensitive adhesive tape. In another embodiment, only the case comprises attachment members such as elastic bands, opposing pocket member such as corner pockets, or frame members that hold the optical film in contact with the illuminated surface. The same attachment members may retain the illuminated display device within the case.

### BRIEF DESCRIPTION OF THE DRAWINGS

FIG. 1 is a perspective view of an exemplary microstructured article;

FIG. 2 is a perspective view of an exemplary light-collimating film;

FIG. 3 is a perspective view of another exemplary-light-collimating film;

FIG. 4A is a photograph of one illustrative case comprising an integrated optical film next to a tablet illuminated display device;

FIG. 4B is a photograph showing the optical film of the case of FIG. 4A disengaged with the illuminated display surface;

FIG. 4C is a photograph showing the optical film of the case of FIG. 4A engaged with the illuminated display surface;

FIG. 5 is a perspective view of an illustrative multi-panel case comprising an integrated optical film;

FIG. 6 is a perspective view of another illustrative case comprising an integrated optical film;

FIG. 7 is a photograph showing an illustrative unassembled case kit;

FIG. 8 is a photograph of the case kit of FIG. 7 assembled.

FIG. 9 is another embodiment of an illustrative unassembled case kit;

FIG. 10 illustrates the assembly of the case kit of FIG. 9;

FIG. 11 is another case suitable for a tablet computer;

FIG. 12 is another case suitable for a tablet computer;

FIG. 13 is an illustrative unassembled case kit comprising the case of FIG. 11; and

FIG. 14 illustrates the assembly of the case kit of FIG. 13.

### DETAILED DESCRIPTION

Presently described are cases suitable for electronic illuminated display devices comprising an integrated optical film. By integrated, it is meant that the optical film is joined to the case. In some embodiments, the optical film is permanently joined to the case. In other embodiments, the optical film is removably attached to the case. Integrating the optical film with the case in a removable manner facilitates replacing the film (without replacing the entire case) in the event the optical film becomes damaged. Integrating the optical film with the case in a removable manner can also provide a means of disengaging the optical film with the illuminated display surface.

As used herein, “optical film” refers to a light transmissive film in the optical path of the display that substantially alters at least one optical property as compared to viewing the display in the absence of the optical film. Examples of optical films include antiglare films, antireflective films, light-collimating films (also referred to as privacy filters), as well as certain films having a coating that reduces the visibility of fingerprints such as described in U.S. Publication No. 2012/0154811; incorporated herein by reference. Films that reduce the visibility of fingerprints exhibit a reduction in haze, a haze ratio of initial (simulated) fingerprint visibility to (simulated) fingerprint visibility at 20 minutes of less than 0.80, 0.70, 0.60, or 0.50.

Light-collimating films typically exhibit at least 60% transmission at a viewing angle of 0 degrees. However, other optical films typically exhibit a transmission of at least 80%, 85%, or 90%.

In some embodiments, known cases for illuminated display devices can be adapted to comprise an integrated optical film. For example, a non-optical light transmissive (e.g. protective) film that does not substantially alter at least one optical property can be replaced with an optical film.

In other embodiments, the described cases for an illuminated display device are not believed to be known. Although optical films are favored, such cases may alternatively comprise a non-optical light transmissive film that does not substantially alter at least one optical property as previously described.

Various antiglare films have been described in the art. As described at paragraph 0039 of US 2007/0286994, matte antireflective films typically have lower transmission and higher haze values than equivalent gloss films. For examples the haze is generally at least 5%, 6%, 7%, 8%, 9%, or 10% as measured according to ASTM D1003. Further gloss surfaces typically have a gloss of at least 130 as measured according to ASTM D 2457-03 at 60° ; whereas matte surfaces have a gloss of less than 120.

There are several approaches for obtaining matte films. For example, matte coating can be prepared by adding matte particles, such as described in U.S. Pat. No. 6,778,240. In yet another approach, the surface of an antiglare film can be roughened or textured to provide a matte surface. According to U.S. Pat. No. 5,820,957; “the textured surface of the anti-reflective film may be imparted by any of numerous texturing materials, surfaces, or methods. Non-limiting examples of texturing materials or surfaces include: films or liners having a matte finish, microembossed films, a microreplicated tool containing a desirable texturing pattern or template, a sleeve or belt, rolls such as metal or rubber rolls, or rubber-coated rolls.” In some embodiments, the antiglare film may have certain microstructure characteristics that can be obtained by microreplication, such as described in W02010/141345; incorporated herein by reference.

Various antireflective films have also been described in the art. As used herein, antireflective film refers to a film that provides an average reflectance of no greater than about 2%, or 1.5%, or about 1% at 550 nm as measured with a spectrophotometer. Antireflective films generally comprise at least two layers having differing refractive indices. Some illustrated antireflective films are described in U.S. Patent Publication No. US2010/0232021 and W02011/140018; incorporated herein by reference.

In some favored embodiments, the optical film of the electronic display device case is a light-collimating film, also referred to as a privacy filter or privacy film. Various light-collimating films are known. In some favored embodiments, light-collimating films typically include a light transmissive film having a plurality of parallel grooves wherein the grooves comprise a light-absorbing material. See for example U.S. Pat. Nos. 4,621,898; 5,204,160; 6,398,370 and 8,012,567.

Light-collimating films can be placed proximate a display surface, image surface, or other surface to be viewed. At normal incidence, (i.e. 0 degree viewing angle) where a viewer is looking at an image through the light-collimating film in a direction that is perpendicular to the film surface, the image is viewable. As the viewing angle increases, the amount of light transmitted through the light-collimating film decreases until a maximum viewing angle is reached where substantially all the light is blocked by the light-absorbing material and the image is no longer viewable. This can provide privacy to a viewer by blocking observation by others that are outside a typical range of viewing angles.

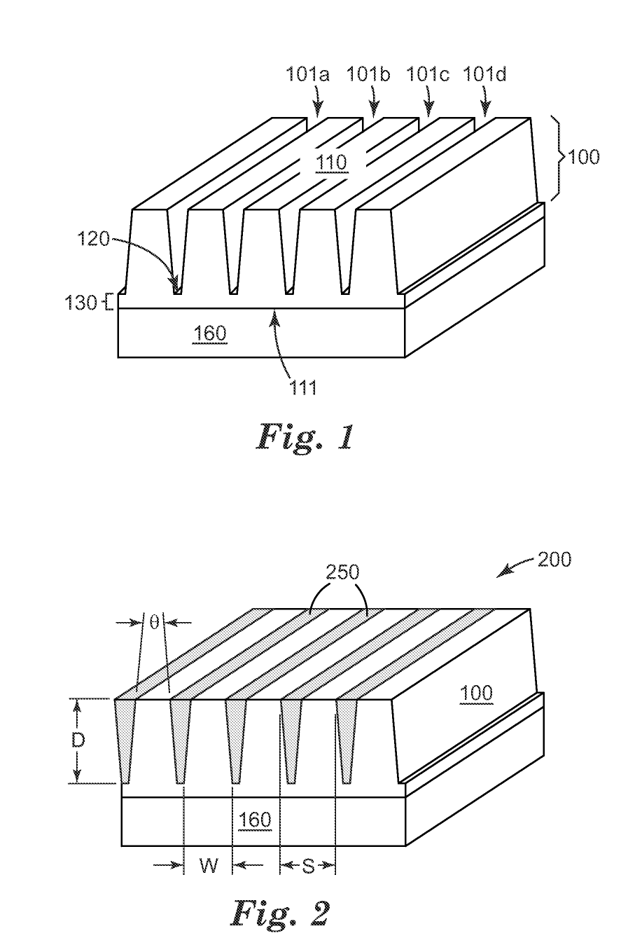

FIG. 1 shows an exemplary microstructured film article 100 comprising at least one microstructured surface 110. An embodied microstructured surface commonly employed for light-collimating films includes a plurality of grooves 101a-101b. As shown in FIG. 1, a continuous land layer 130 may be present between the base of the grooves 120 and the opposing (e.g. unstructured, substantially planar) surface 111 of the film 100. Alternatively, the grooves may extend all the way through the film.

The microstructured article typically includes a base substrate layer 160. Examples of preferred base substrate layers include polyethylene terephthalate (PET) and polycarbonate. Examples of useful PET films include photograde polyethylene terephthalate and MELINEX™ PET available from DuPont Films of Wilmington, Del. Polycarbonate films are available from Sabic and Longhua (China).

FIG. 2 shows an embodied light-collimating film 200 wherein the grooves of FIG. 1 have been rendered light-absorbing by being filled with a light absorbing material 250. The light absorbing material in the shape of the recess of the (e.g. groove) microstructure is referred to herein as a light absorbing element.

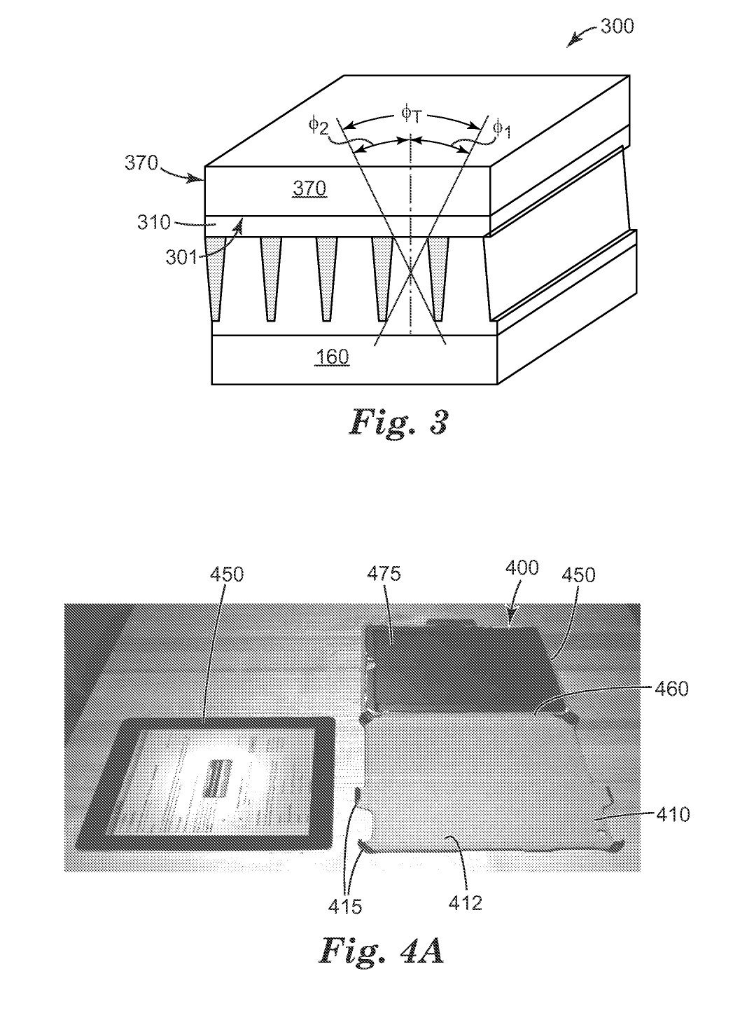

FIG. 3 shows another embodied light-collimating film 300 that further includes a cover film 370 that is typically the same film as the base substrate layer 160 bonded to the microstructured surface with for example an (e.g. UV-curable acrylate) adhesive 310.

As depicted in FIG. 2 or 3, the transparent microstructures between grooves have an included wall angle θ as depicted in FIG. 2, a maximum transparent microstructure width, W; an effective height D; center-to-center spacing, S; and a maximum viewing range Φ_{T}. Wall angle θ is equal to 2 times the angle formed between the transparent film interface with the light absorbing element nearly along the “D” dimension direction and a plane normal to the microstructured surface. The viewing range Φ_{T} is about twice the maximum viewing half angle. The viewing range Φ_{T} can also be asymmetric for example when the half angle Φ₁ is not equal to the half angle Φ₂.

It is appreciated that transmission is a factor of the polymerizable resin of the light-collimating film as well as the included wall angle. In some embodiments, the transmission at an incident angle of 0° is at least 56%. The transmission at an incident angle of 0° can be at least 70% (e.g. 71%. 72%, 73%, 74%, 75%). The transmission can be measured with various known techniques. As used herein, the on-axis transmission was measured with an instrument commercially available from BYK Gardner under the trade designation “Haze-Guard Plus (catalog # 4725).”

Light-collimating films can be made that have relatively large included wall angles. Larger wall angles can increase the maximum width of the light absorbing regions, thereby decreasing the percent transmission at normal incidence.

In preferred embodiments, the included wall angle of the microstructures averages less than 6° and more preferably averages less than 5° (e.g. less than 4° , 3° , 2° , 1° , or 0°).

Smaller (i.e. steeper) wall angles are amenable to producing grooves having a relatively high aspect ratio (H/W) at a smaller center-to-center spacing S, thereby providing a sharper image viewability cutoff at lower viewing angles. In some embodiments, the transparent microstructures have an average height, H, and an average width at its widest portion, W, and H/W is at least 2.0, preferably 2.5, and more preferably 3.0 or greater.

Depending on the intended end use light collimating films having a variety of viewing cutoff angles can be prepared. In general, the viewing cutoff angle ranges from 40° to 90° or even higher. The following Table 1 provides exemplary viewing cutoff angles as a function of aspect ratio.

TABLE 1

| Aspect Ratio | View Angle (deg) |
|---|---|
| 1.50 | 120 |
| 1.75 | 100 |
| 2.0 | 90 |
| 3.0 | 60 |
| 4.0 | 48 |
| 5.0 | 40 |

For computer privacy films as well as hand-held devices, cutoff viewing angles are preferably 60° or less.

In some embodiments, the pitch is no greater than 0.040 mm, 0.039 mm. 0.038 mm, 0.037 mm, 0.036 mm or less. A smaller included wall angle and less pitch allows for higher performance with less height. In some embodiments, the height is no greater than 0.10 mm, or 0.090 mm, or 0.080 mm, or 0.070 mm. Light-collimating films having such reduced height are further described in WO2010/148082; incorporated herein by reference. Less height results in less overall thickness of the film. Thinner films tend to have better touch sensitivity.

Light absorbing materials useful for forming light absorbing regions in light collimating films of the present invention can be any suitable material that functions to absorb or block light at least in a portion of the visible spectrum. Preferably, the light absorbing material can be coated or otherwise provided in grooves or indentations in a light transmissive film to form light absorbing regions in the light transmissive film. Exemplary light absorbing materials include a black or other light absorbing colorant (such as carbon black or another pigment or dye, or combinations thereof) dispersed in a suitable binder. Other light absorbing materials can include particles or other scattering elements that can function to block light from being transmitted through the light absorbing regions.

The light absorbing material may comprise substantially the same polymerizable resin composition as the film with the exception of the inclusion of pigment or dye. The amount of (e.g. carbon black) colorant is typically at least about 2 wt-% and no greater than about 10 wt-%. One exemplary light absorbing composition is described in Example 3 of U.S. Pat. No. 6,398,370.

To reduce reflections at the light transmissive film/light absorbing material interface, it may be desirable to match or nearly match the index of refraction of the transmissive film material with the index of refraction of the light absorbing material over all or a portion of the visible spectrum. Reducing such reflections tends to reduce the formation of ghost images.

Although the inclusion of a plurality of parallel light absorbing grooves is most common, the light-collimating film may alternatively include a plurality of light absorbing columns such as shown in FIG. 2b of U.S. Pat. No. 6,398,370; incorporated herein by reference. In addition, the light-collimating film described herein may be combined with a second light-collimating film, as also described in U.S. Pat. No. 6,398,370.

Light-collimating films are commercially available from 3M and are also distributed by Elecom of Japan. Light-collimating films commercially available for use with notebook computers typically comprise tabs on the periphery of the film that are intended to fit between the peripheral housing of the illuminated display and the display surface to hold the film in contact with and in a plane parallel to the illuminated display.

Another type of optical film that can provide some degree of privacy are multi-layer (e.g. color shifting) films such as described in US 2010/0201242.

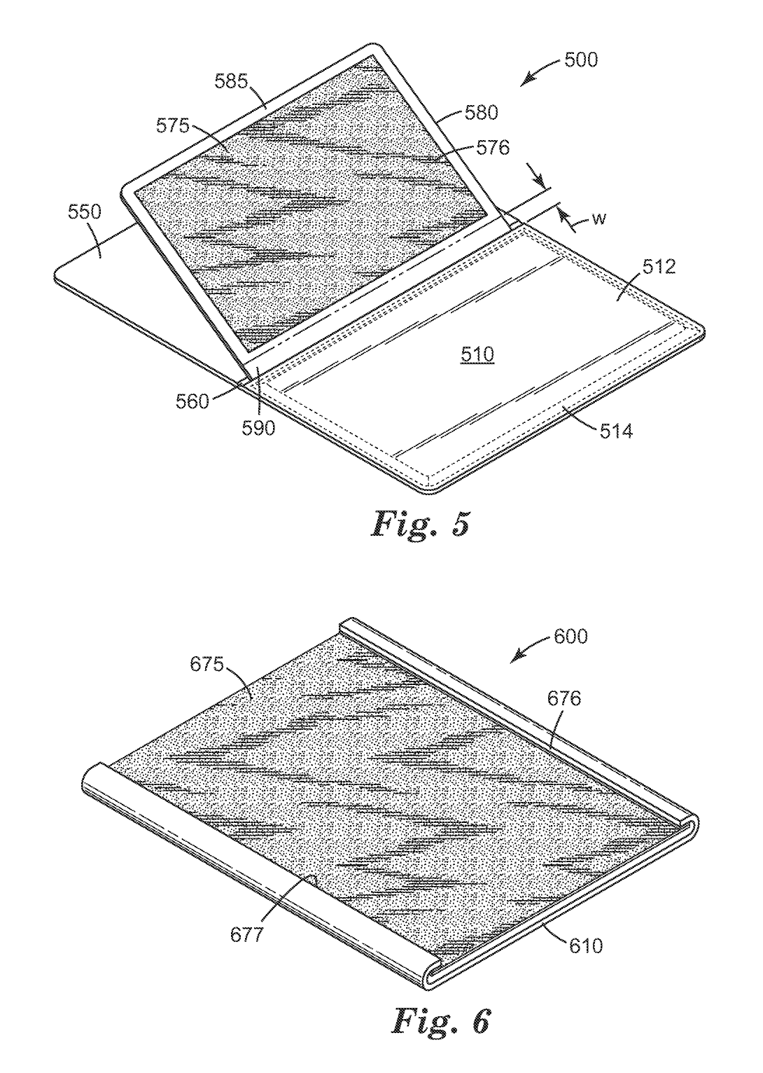

In some embodiments, the case may comprise a single optical film that comprises more than one type of optical film laminated together. For example, the optical film may comprise a light control film and a multilayer (e.g. color shifting) optical film as described in US 2010/0201242. In other embodiments, a single optical film may (e.g. concurrently) alter more than one optical property. For example, some antireflective films are also antiglare. In yet other embodiments, a single case may comprise more than one optical film. For example, when the case is a multi-panel case, such as shown in FIG. 5 the case may comprise two or more interior panels between the front and back panels. The interior panels may comprise different types of optical films, such as a privacy film and a film that reduces the visibility of fingerprints. In some embodiments, the interior panels can be used in combination by being stacked on top of each other on the illuminated display surface.

During use of the illuminated display device the non-viewing surface of the optical film is typically flush with the illuminated display device. The non-viewing surface of the optical film typically comprises slight surface roughness to prevent optical coupling with the illuminated display surface.

Cases for electronic illuminated display devices can have various designs. Typically the case comprises a back panel that during use is in contact with the back or non-viewing surface of the illuminated display device. During use at least a portion of the case is typically in contact with the sides of the illuminated display device. The sides are orthogonal to the front and back and correspond to the thickness of the illuminated display device. The sides of the case are typically equal to or slightly greater than the thickness of the illuminated display device. The thickness of the illuminated display device typically ranges from about 0.35 inches to about 0.50 inches.

The interior face of the (e.g. back) panel of the foldable cases and other case designs typically comprises an attachment mechanism (e.g. attachment members) for removably attaching the illuminated display device to the case. Various attachment mechanisms can be used including for example raised rigid corners, a raised rigid or flexible frame, rigid or flexible corner pockets, opposing pockets member, magnets, elastomeric bands, hook and loop fasteners, as well as (e.g. removable) adhesive (e.g. tapes) including for example stretch release adhesive tapes available from 3M, St. Paul, Minn. under the trade designation Command.

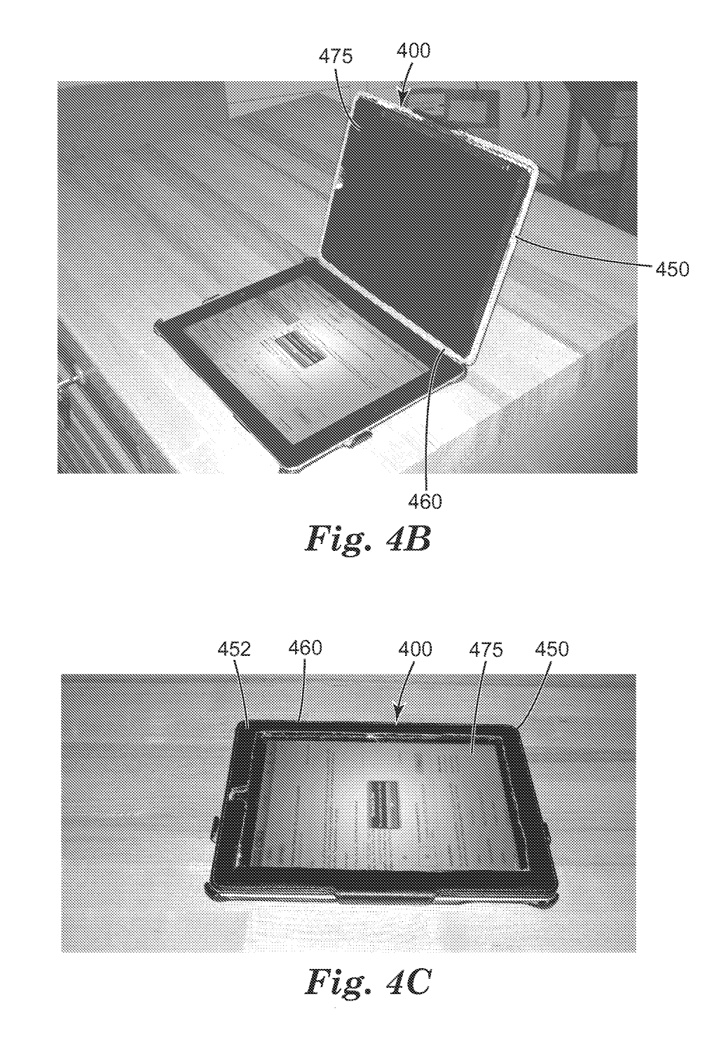

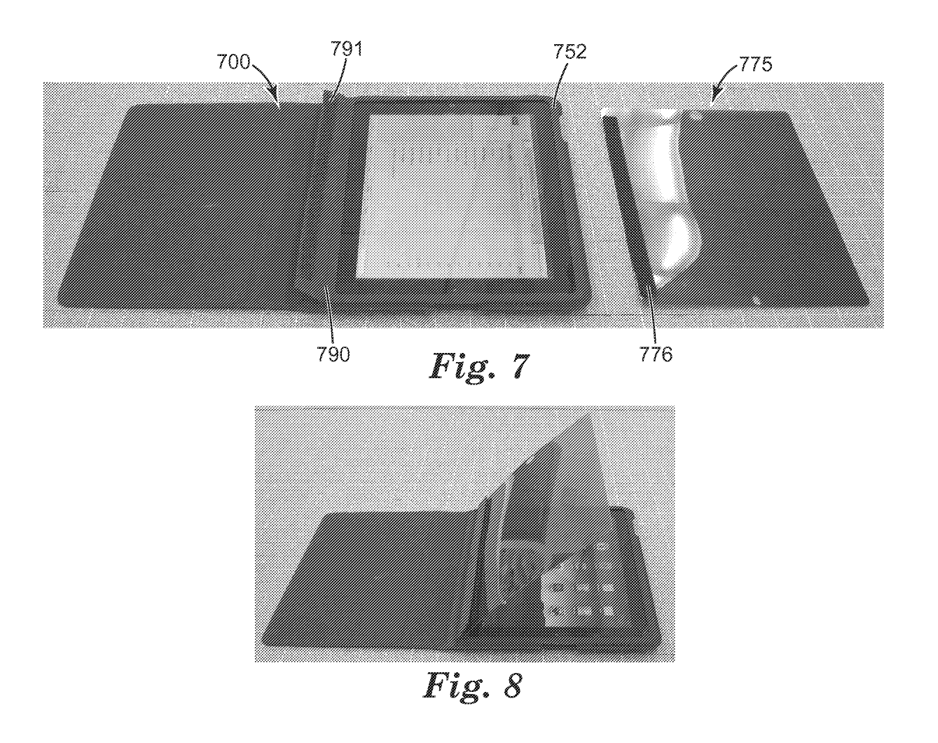

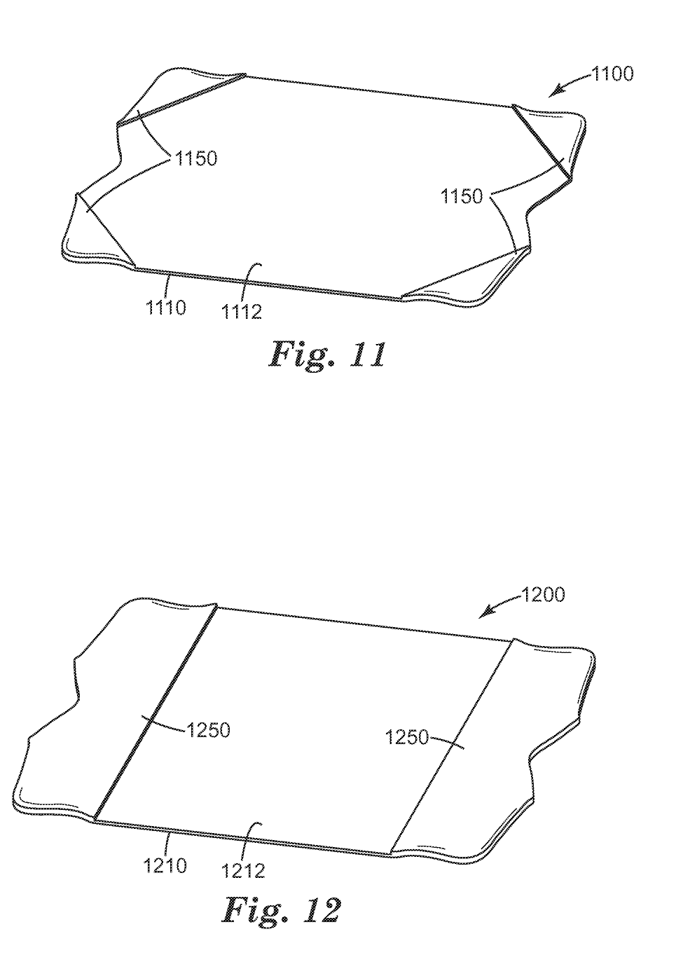

The case may include only corner members that contact the corners of the illuminated display device (as shown in FIGS. 11 and 12-14), a combination of corner members and at least one side member (e.g. such as shown in FIGS. 4A-4C). The case may comprise opposing pocket members (such as shown in FIG. 12). The case may comprise continuous frame members on opposing sides (e.g. such as shown in FIG. 6) or about the entire periphery of the case (e.g. such as shown in FIGS. 7-8). Such (e.g. rigid) side members and frame members may only come in contact with the side of the illuminated display device during use (e.g. such as shown in FIGS. 4A-4C). Alternatively corner members, opposing pocket members, side members, and frame members may further come in contact with a peripheral portion of the front surface of the illuminated display surface, including peripheral opposing sides, or the entire periphery. However, the portions of the case that contact the front surface of the illuminated display device typically contact only the periphery or peripheral portions and not the illuminated display area (e.g. such as shown in FIGS. 7-8).

These same attachment mechanisms (as used to attach the case to the illuminated display device) can be used to attach the optical film or framed optical film to the case. The optical film or framed optical film can also be permanently attached to the case. By permanently attached, it is meant that the optical film or framed optical film cannot be removed from the case without damaging the case, the optical film, or the frame, etc. The optical film or framed optical film can be permanently bonded by any suitable means including for example by use of a book binding adhesive along an edge (e.g. edge 560 of FIG. 5), by permanently adhesively bonding the optical film to the frame wherein the frame is bound along a common edge (e.g. 560 of FIG. 5), or by sewing, adhering, heat-welding, etc. the optical film or framed optical film to a flexible hinge (e.g. shown with a hook fastener in FIG. 7) wherein the flexible hinge is attached to the case.

In other embodiments, the cases described here are not foldable and typically lack an attachment mechanism for attaching the illuminated display device to the case. Such cases may be described as having a sleeve or pocket design, such as depicted in FIG. 6 and FIGS. 11-13. In this embodiment, at least the back panel of the case typically comprises an elastomeric material. The case is slightly smaller than the size of the device it is intended for use with such that the retractive forces of the elastomeric material maintain the illuminated display device within the case.

In some embodiments, the (e.g. light-collimating) optical film may be removably attached to the case or the optical film may be removably attached to a panel, the panel being permanently bonded to the case. When removably attached, the (e.g. light-collimating) optical film may be replaced without replacing the case. When the optical film is removably attached to the case, the case and optical film may be provided as separate parts of a case kit that may be subsequently assembled such that the optical film is integrated with the case. In some embodiments, the case and the optical film or the case and a panel comprising the optical film may comprise cooperating attachment mechanisms, such as a hook and loop fastener.

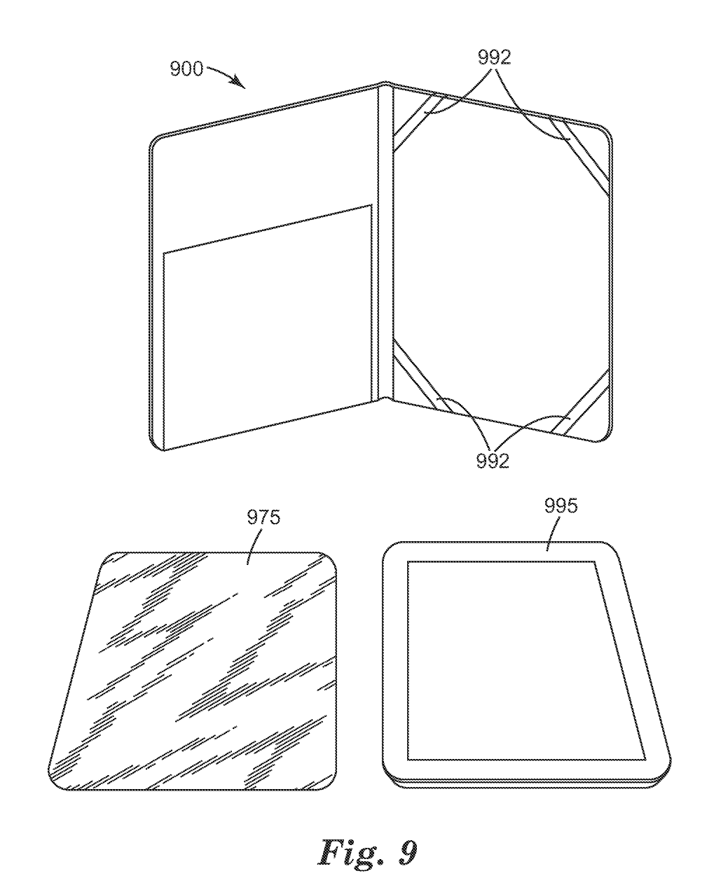

In other embodiments, such as depicted in FIGS. 9-13, only the case comprises opposing attachment members. Such attachment members may include for example elastic bands, corner pockets, or opposing pocket members that hold the optical film in contact with the illuminated surface. In some embodiments, the same attachment members retain the (e.g. tablet) electronic device within the case.

In yet another embodiment, the case kit may comprise a case and/or panel that is designed to hold or contain the optical film. For example, the optical film may be held by a double-sided framed panel that has an opening along one edge to receive the optical film. The case of FIG. 5 may be adapted in this manner.

In yet other embodiments, the case kit comprises a case and optical film that do not comprise cooperating attachment mechanisms. Rather a separate attachment mechanism, such a double-faced pressure sensitive adhesive tape may be utilized to attach the optical film to the case or panel.

Various known cases for electronic illuminated display devices can be adapted to comprise an integrated optical film. Some examples of computer cases are described in U.S. Pat. No. 7,907,394 and U.S. Pat. No. 6,356,400; incorporated herein by reference. U.S. Pat. No. 6,356,400 describes a notebook computer having a resilient, portfolio-type case that includes a large flat-panel display module and a processor keyboard module constructed into the case so that the case need not be stored separately.

These patents are examples of computer cases wherein the illuminated display device are not intended to be removed from the case during use. Any illuminated display device that is intended to remain attached to the device during use can benefit from an integrated optical film, such as a light-collimating film.

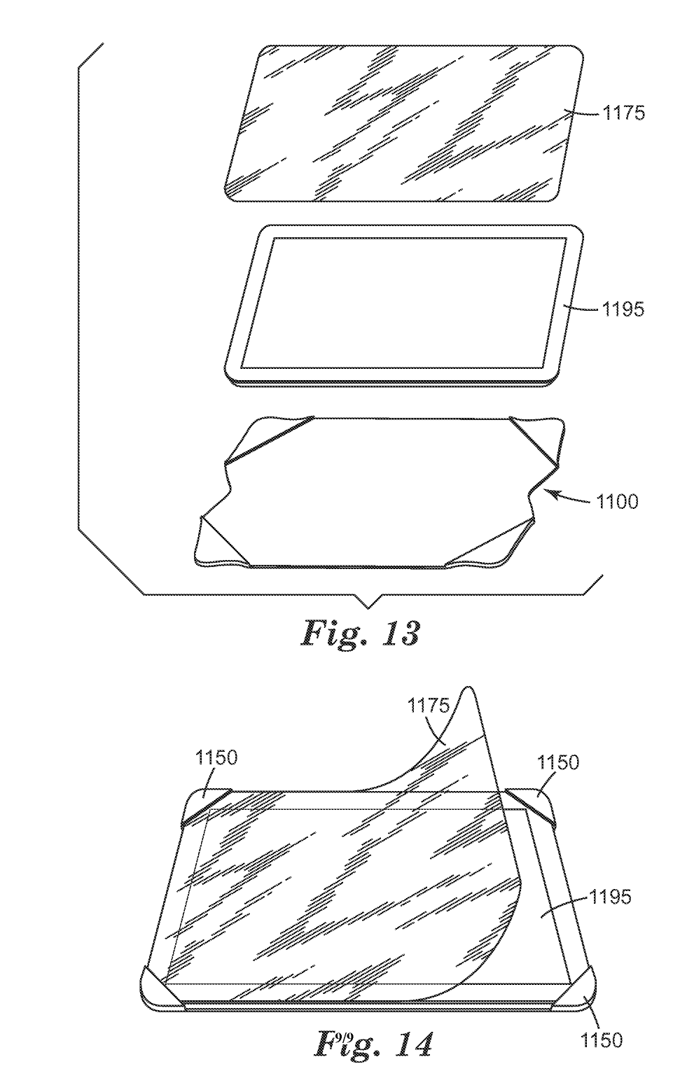

U.S. Pat. No. 7,907,394 describes a notebook computer having a resilient, portfolio-type case that includes a larger flat-panel display module and a processor-keyboard module constructed into the case so that the case need not be stored separately during use. One way of adapting the case described in U.S. Pat. No. 7,907,394 to comprise an integrated optical film is to replace membrane 110 with an optical film, such as a light-collimating film. Another way of adapting the case described in U.S. Pat. No. 7,907,394 is to leave membrane 110 in place as described and attach a light-collimating film to the exterior membrane, such as by attaching a hook and loop type fastener to at least one edge of the light-collimating film and at least one edge of the outer cover, such as the protective overmolding depicted in FIG. 13A of U.S. Pat. No. 7,907,394. Yet another way of adapting the case described in U.S. Pat. No. 7,907,394 is to leave membrane 110 in place as described and attach a light-collimating film to the interior membrane such as recessed portion 120 (shown in FIG. 2 U.S. Pat. No. 7,907,394) that presses flat against the touch screen. When a light-collimating film is attached to the membrane, the membrane together with the light-collimating film are preferably of a sufficiently low thickness as to not detract from touch-sensitivity.

The case described in U.S. Pat. No. 6,356,400 can be adapted to include an integrated optical film by providing a (e.g. hook and loop) fastener along the top edge or side edge of the half of the case intended for the flat panel display assembly. A (e.g. hook and loop) fastener can be adhered to the top edge or side edge of a (e.g. light-collimating) optical film having dimensions the size of the display. The (e.g. hook and loop) fastener of the case can then be mated with the edge of the optical film. By attaching the optical film along a single edge with a flexible hinge, the film can be flipped up and down or side to side to engage or disengage the optical film with the illuminated display surface.

Various favored embodiments of the invention will be described with respect to a more recent electronic illuminated display device, commonly referred to as a “tablet” comprising a favored optical film, i.e. a light-collimating film. However, such cases may also be suitable for other illuminated display devices. Further, such cases may comprise other optical films instead of or in combination with the light-collimating film. As used herein, tablet refers to an electronic display device that does not hinge open and closed (such as in the case of a flip phone, laptop computer, or the like). In some embodiments, the tablet may primarily be a display device (such as an electronic reader). Other tablet electronic devices, such as computers, typically have touch-sensitive keyboard functionality integrated into the display. Thus, the display and keyboard components are one in the same, rather than separate components. In other words, a tablet computer can be considered to lack a keyboard component that is a separate component than the display.

When the tablet electronic device is touch-sensitive, the optical films are preferably of a sufficiently low thickness as to not detract from the touch-sensitivity. In some embodiments, the thickness of the optical film or an optical film stack is no greater than 0.025 inches, or 0.020 inches, or 0.010 inches (e.g. 0.0085 inches).

The cases described herein are suitably sized and shaped closely to the dimensions of the electronic display it is intended for. Although the cases are not limited in shape, since commercially available tablets are generally rectangular in shape, the illustrative cases depicted herein are generally rectangular in shape as well.

The cases can be made from a variety of natural and synthetic materials such as leather as well as various rigid and flexible plastic materials. When the case is made of a non-elastomeric material, the case is typically slightly larger than the device. However, when the case is made of an elastomeric material, the case may be slightly smaller than the device. Tablet computers are typically larger in size than a hand-held electronic illuminated display device typically having a diagonal of no greater than 4 inches.

In some embodiments, the cases are for tablet computers having a diagonal of greater than 4, 5, or 6 inches. For example, the tablet may have a diagonal of at least 7, 8, 9, or 10 inches and typically no greater than 15 or 20 inches.

The case material may have various colors and designs. The case material may be smooth or textured, such as by embossing, to have various appearances and tactile qualities. The exterior of the case may comprise a different material than the inside of the case or interior panels of the case.

The thickness of the case material depends at least in part on the selection of material. In some embodiments, the thickness of the material is at least 1 mm or 1.1 mm or 1.2 mm. The thickness is typically no greater than 5 mm, or 4mm, or 3 mm, or 2 mm. In some embodiments, the thickness is no greater than 1.9 mm or 1.8 mm.

In some embodiments, the case material has a basis weight as determined according to ASTM D3776 of at least 10, 11, 12, 13, 14, or 15 oz/yd² and typically no greater than 25 oz/yd².

Further, the case material typically has a compression resistance of at least 5 lbs at 50% deflection (for a thickness of 1.5 to 2 millimeters).

In some embodiments, elastomeric materials can be utilized to make the entire case or a portion thereof. In some embodiments, the back panel comprises an elastomeric material (such as the embodiments of FIGS. 6 and 11-13). In some embodiments, the case comprises corner pockets or opposing pocket members comprising an elastomeric material, such as the same elastic material as the back panel.

The elastomeric material typically has an elongation of at least 50% and no greater than 150%. Elongation refers to the extent the material can stretch and substantially recover (within a few percent) to its original unstretched dimension. In some embodiments, the elastomeric material has an elongation of no greater than 100, or 90, or 80%.

The force of recovery of an elastomeric fabric material can be determined according to ASTM D4964. This retractive force aids in maintaining a stretched case on the electronic display device. If the force is too low, the case may not stay one the device. If the force is too high, it may be difficult to insert the device into the case. In some embodiments, the force at 25% elongation ranges from about 0.50 to about 1 pound. In some embodiments, the force at 50% elongation ranges from about 1.5 to about 2.5 pounds.

A variety of elastomeric materials can be utilized to make the case. Elastomeric fabric materials generally comprise longitudinally extending elastic yarns in a woven, knitted, or nonwoven material. In one embodiment, the elastomeric material is a laminate wherein at least one layer comprises foamed neoprene or a high density polyurethane foam. The laminate typically comprises at least one exterior fabric layer, such as a light weight nylon or polyester jersey knit. In some embodiments, the case material is a laminate having an interior layer comprising neoprene or a high density polyurethane foam sandwiched between outer fabric layers.

The case material, and in particular the interior surfaces (of the back panel, corner pockets, or opposing pocket members) that come in contact with the surfaces of the illuminated display device, preferably has a sufficiently high coefficient of friction such that the case is more easily retained within the case. When the optical film is joined with the case, such high coefficient of friction case material can also aid in retaining the optical film is place and preventing the film from moving when “swiping” or sliding one's finger across a touch display. As used herein, coefficient of friction refers to the coefficient of friction between a (e.g. fabric) case material and a surface treated (e.g. alkalialuminosilicate) glass, having a static contact angle with water of about 110 degrees using an inclined plane test. One example of a suitable glass is “CORNING® GORILLA® glass with Easy-to-Clean Coating”, available from Corning Inc., Corning N.Y. Such glass has similar surface properties as commercially available tablet illuminated display devices. Coefficient of static friction was determined by taping a 400 gram cylindrical weight (having a diameter of about 4 cm and a height of about 4 cm) to a piece of (e.g. fabric) case material, opposite from the (e.g. fabric) case material surface to be tested. The surface treated glass was placed flat on a table with the surface to be tested facing up and the (e.g. fabric) case material with the attached weight was placed on the top of the glass with the fabric surface to be tested contacting the glass. The glass was approximately rectangular having a length L (i.e. the length of the inclined plane).

One edge of the piece of glass was slowly lifted until the weighted (e.g. fabric) case material started to slip down the length of the inclined plane. The height of the lifted edge, h, was recorded and the coefficient of static friction, μ, was determined from the equatior

$$μ = \frac{h}{\sqrt{{L}^{2} - {h}^{2}}} .$$

In preferred embodiments, the coefficient of friction was at least 0.5, or 1, or 1.5, or 2.

In some embodiments, the fabric itself may have a sufficiently high coefficient of friction. In other embodiments, the case material comprises a polymeric coating to modify (e.g. increase) the coefficient of friction. Although such coating may also be used with non-elastomeric case materials as well, such coating is preferred when the case comprises an elastomeric material that is stretched and has the tendency to retract during use with the illuminated display device. Such polymeric coating together with the retractive forces of the elastomeric material may be considered to “grip” the case.

The coating may be comprised of various polymeric materials including for example polyurethanes, silicones, neoprene, natural or synthetic rubber (including latexes) such as styrene butadiene rubber, acrylonitrile butadiene rubber (e.g. nitrile), ethylene propylene diene rubber (e.g. EPDN.4) The thickness of the coating is typically at least 1 to 2 mils and generally no greater than 10, 9, 8, 7, 6, or 5 mils. The inclusion of the coating typically increase the coefficient of friction by at least 0.2, or 0.5, or 1 or 2.

One illustrative elastomeric fabric having a sufficiently high coefficient of friction is available from Nam Liong (U.S.A.) Inc. (Ontario, Calif.), described as 1.7 mm black nylon spandex+wine orca skin.

The back panel may comprise a plurality of openings or perforations to aid in dissipating heat (generated by the electronic device) through the case material (e.g. of the back panel). For example, case material may comprise a plurality of perforations or openings up to ⅛ inch in diameter spaced apart by a distance of about ½ inches. In some embodiments, the cases are foldable cases. The foldable cases can be opened for the purpose of providing or removing the tablet from the case. The foldable cases comprise at least one panel comprising a (e.g. light-collimating) optical film that can be engaged or disengaged with the illuminated display surface, such as by opening and closing the case.

FIGS. 4A-4C depict photographs of one embodiment of a foldable case 400 suitable for a tablet computer. FIG. 4A depicts a perspective view of the case in an open position adjacent a tablet illuminated display device 450. With reference to 4A, the case comprises a first (e.g. back) panel 410 having an interior surface 412 comprising an attachment mechanism (e.g. such as a raised corner and side members 415) suitable for attaching an illuminated display device, such as illuminated display 450. The illuminated display device is attached such that the back face (i.e. non-display surface) contacts interior surface 412 of the case as shown in FIG. 4B. With reference to FIG. 4A-4C, the case further comprises a second (e.g. front) panel 450 connected to the first panel 410 along an edge 460. The second panel 450 comprises light-collimating film 475. The case folds open and closed along edge 460 that connects the first panel 410 and second panel 450. The second (e.g. front) panel 450 comprising optical film 475 can rotate at least about 90 to 180 degrees, in a similar manner as turning a page in a book. When the case is open, as depicted in FIG. 4B, light-collimating film 475 is not engaged with the illuminated display surface. Thus, when the case is open, the illuminated display device can be considered to be in “share mode”. When the case is closed, as shown in FIG. 4C, the light-collimating film is engaged with the illuminated display surface by lying flush with the illuminated display surface between the viewer and the illuminated display surface. The illuminated display is viewable through the light-collimating film 475 of the second panel 450. Thus, when the case is closed, the illuminated display device is in privacy mode since viewers at a viewing angle of 60 degrees or greater are unable to see the illuminated display.

With reference to FIG. 4C, a perspective view of the case in a closed position, the second panel 450 comprises an exterior surface comprising a frame 452. The light-collimating film 475 is recessed relative to the frame. When the illuminated display device is removed from the case and the case is closed (not shown) the interior face 412 (of FIG. 3A) of the first panel 410 is proximate to and in a plane substantially parallel to the light-collimating film 475. Although light-collimating films 475 generally has a dark appearance, such films are light transmissive. Thus, the interior face 412 of the first panel 410 is visible through the light-collimating film 375.

In some embodiments, the case of FIG. 4A is preassembled for example by bonding the peripheral edges of the light collimating film to the inside surface of the frame of the second (e.g. front panel) with for example an adhesive. When the adhesive is a removable adhesive, the light collimating film is removably attached to the frame.

In another embodiment, the case of FIG. 4A may not be preassembled. Rather, the case and the optical film may be available as a case kit.

The case kit may include the foldable case comprising a front panel with an opening. The case kit further comprises an optical film (suitable sized for the opening) having a double-faced adhesive tape applied to the periphery of the optical film. Alternatively, the optical film and double-faced tape may be provided in the kit as separate components. The optical film may be removably or permanently attachable to the inside frame of the front panel by various other attachment means as previously described.

FIG. 5 depicts a perspective view of the interior of another embodiment of a foldable case 500 in an open position. With reference to FIG. 5, the case comprises a first (e.g. back) panel 510 having an interior surface 512 comprising an attachment mechanism suitable 514 (e.g. a flexible frame member) for attaching an illuminated display device. The case further comprises a second (e.g. front) panel 550 connected to the first panel 510 along an edge 560 that can function as a protective cover. This case further comprises at least one additional panel 580 between the first (e.g. back) panel 510 and second (e.g. front) panel 550 comprising a (e.g. light-collimating) optical film 575. The additional panel 580 is also connected along the same edge 560 the first and second panel are connected. The case folds open and closed along edge 560. When closed the interior surface 512 of the first (e.g. back) panel 510 panel is proximate and in a plane substantially parallel to optical film 575, i.e. prior to an illuminated display device being attached to the interior surface 512. When open (e.g. such as when placed on a table), the additional panel(s) 580 comprising optical film 575 can rotate at least about 90 to 180 degrees in a similar manner as turning a page in a book. Thus interior surface 576 of additional panel(s) 580 comprising optical film 575 can contact and preferably lie flush against the illuminated display surface or the opposing surface of the additional panel(s) (not shown) can contact the interior surface of second (e.g. front) panel 550 when not engaged with the illuminated display surface. Thus, when the optical film is a light-collimating film the illuminated display surface can be switched from share mode to privacy mode by rotating the film onto the display surface. Although FIG. 5 depicts only one additional interior panel comprising an optical film for simplicity, such case may optionally comprise two or more interior panels with different optical functionality, as previously described. In FIG. 5, the optical film is provided in a rigid frame member 585. Such a frame member can facilitate the thin optical film in lying flush with the illuminated display surface. The frame member 585 is attached to the common edge 560 by means of a flexible hinge 590 that has a width (“w”) about the same width or slightly greater than the thickness of the illuminated display device intended for use with the case. In some embodiments, the rigid frame member 585 is removably attached to the flexible hinge with for example snaps, a hook and loop fastener, or any other suitable means, such that the rigid frame member comprising the optical film can be removed from and reattached to the case. Although, the framed optical film is depicted as being bound to a common edge of the front and back panel, the framed optical film could alternatively be attached to a flexible hinge that is bonded to a peripheral edge along the top of the back panel, the bottom of the back panel or the opposite side of the back panel. Provided that the optical film is thick enough to lie flush against the illuminated display surface, yet thin enough to provide sufficient touch-sensitivity, the optical film may be attached to flexible hinge 590 in the absence of a frame.

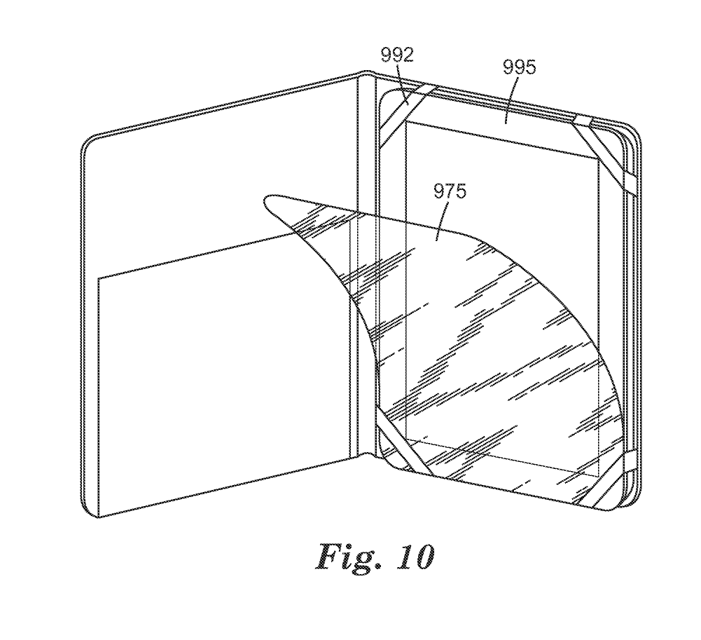

The case with an integrated optical film may be preassembled as shown in FIG. 5. Alternatively, the case and optical film may be provided as an unassembled case kit. For example, FIG. 7 shows a case kit comprising a foldable case 700 having a front panel connected to a back panel along an edge and a flexible hinge 790 material bound to the same edge as the front and back panel. The back panel includes a flexible frame member 752 that retains the back surface of a tablet device in contact with the inside surface. The case 700 and optical film 775 includes cooperating attachment members. The hinge comprises a (e.g. hook) attachment member 791 and the optical film comprises a cooperating (e.g. loop) attachment member 776. The (e.g. hook and loop) cooperating attachment members of the film and case can be attached to integrate the film with the case, as shown in FIG. 8. FIG. 9 depicts another illustrative unassembled case kit. The kit comprises foldable case 900 and optical film 975. The case is suitably size for tablet electronic illuminated display device 995. The case comprises elastic bands 992. Such elastic bands are intended to retain the electronic display device in the case and also retain the optical film in contact with the illuminated display surface. FIG. 10 depicts the assembly of optical film 975 with the case of FIG. 9 after a tablet illuminated display device 995 has also been inserted into the case. In other embodiments, the cases are not foldable (i.e. unfoldable).

FIG. 6 depicts a perspective view case 600 comprising a back panel 610 and a front panel comprising an optical film 675 connected to the first panel along two parallel edges (676 and 677) forming a sleeve. The interior surface of the first panel is visible through optical film 675. As shown the back panel 610 is sufficiently flexible such that it can be folded and bonded to the optical film forming frame members along the two parallel edges the back panel is attached to the optical film. Alternatively, optical film 675 may be provided in a frame member that attaches to the back panel. In this embodiment, the back panel would not be visible in a front plan view. In another embodiment, the back panel is further connected to the first panel along an orthogonal edge forming a pocket. In some favored embodiments, the back panel is made of an elastomeric material. The sleeve or pocket is slightly smaller that the illuminated display device the sleeve or pocket is intended for. Thus, the sleeve or pocket stretches when an electronic device is inserted. In another embodiment, the back panel is not made of an elastomeric material. However, the sleeve or pocket has a custom fit for the intended illuminated display device. In either embodiment, the sleeve or pocket is designed such that the optical film lies flush against the contacting illuminated display surface when the device is inserted. The back panel may be permanently or removably attached to the front panel as previously described.

FIG. 11 is a perspective view of case 1100 suitable for a tablet illuminated display device. The case comprises a back panel 1110 having interior surface 1112 for contacting with the back face of a tablet device. The case further comprises corner pockets 1150 that extend over the sides and a portion of the front surface of the tablet. At least the back panel and preferably the back panel and the corner pockets are preferably comprised of an elastomeric material that stretches when the tablet is inserted into the case. The interior surface may further comprise a polymeric coating that increases the coefficient of friction as previously described.

FIG. 12 is a perspective view of case 1200 suitable for a tablet illuminated display device. The case comprises a back panel 1210 having interior surface 1212 for contacting with the back face of a tablet device. The case further comprises two opposing pockets 1250 that extend over the sides and a portion of the front surface of the tablet. At least the back panel and preferably the back panel and the corner pockets are preferably comprised of an elastomeric material that stretches when the tablet is inserted into the case. The interior surface may further comprise a polymeric coating that increases the coefficient of friction as previously described.

FIG. 13 depicts another illustrative unassembled case kit. The kit comprises foldable case 1110 (of FIG. 11) and optical film 1175. The case is suitably size for tablet electronic illuminated display device 1195. FIG. 14 depicts the assembly of optical film 1175 with the case of FIG. 11 after a tablet illuminated display device 1195 has also been inserted into the case. Although not shown such kit may alternatively comprise the case of FIG. 12.

The cases may further comprise various openings (not shown) to provide access to the power button, camera, USB ports, etc. Such opening can be of various sizes and shapes and be at various locations to accommodate the intended illuminated display device.

1. A case for an illuminated display device comprising:
a case suitable for receiving a tablet illuminated display device; and
a light-collimating optical film attached to the case along an edge such that the optical film can be rotated orthogonal to the edge to engage or disengage the optical film with the illuminated display when the illuminated display device is provided within the case.

2-4. (canceled)

5. The case of claim 1 wherein the optical film is disposed between the interior surface and a viewer of the illuminated display surface when the optical film is engaged with the illuminated display.

6. The case of claim 1 wherein the optical film lies flush in contact with the illuminated display.

7. The case of claim 1 wherein an interior face of the case comprises an attachment mechanism for attaching the illuminated display device.

8. The case of claims 1 comprising a first panel having an interior surface comprising an attachment mechanism suitable for attaching an illuminated display device; and
a second panel connected to the first panel along an edge; wherein the second panel comprises the optical film.

9. The case of claim 8 wherein the case folds open and shut along the edge that connects the first and second panel such that the interior surface of the first panel is in a plane substantially parallel to the optical film prior to the case receiving an illuminated display device.

10. The case of claim 9 wherein the second panel comprises an exterior surface comprising a frame and the optical film is recessed relative to the frame.

11. The case of claim 10 wherein the second panel comprises an interior surface comprising a frame and the optical film is between the frames of the exterior and interior surfaces of the second panel.

12. The case of claim 8 wherein the optical film is permanently attached to the second panel.

13. The case of claim 12 wherein the second panel is permanently attached to the case.

14. The case of claim 12 wherein the second panel is removably attached to the case.

15. The case of claims 8 wherein the optical film is removably attached to the second panel.

16. The case of claims 8 wherein the first and/or second panels comprise a refastenable mechanism on an opposing edge for temporarily attaching the panels to each other or the second panel to the illuminated display surface.

17. The case of claim 1 wherein the optical film or panel comprising an optical film is attached to an edge of the case by means of a flexible hinge.

18-22. (canceled)

23. A case for an illuminated display device comprising:
a back panel having an interior surface comprising an attachment mechanism suitable for attaching an electronic display device; and
a front panel connected to the back panel along an edge such that the case is foldable along the edge; and
at least one additional panel disposed between the back and front panel wherein the additional panel comprises an optical film.

24-32. (canceled)

33. A case kit for an illuminated display device comprising:
a case suitable for receiving an tablet illuminated display device; and
light-collimating optical film for attachment to the case along an edge such that the optical film can be rotated orthogonal to the edge to engage or disengage the optical film with the illuminated display when an illuminated display device is provided within the case.

34. The case kit of claim 33 wherein the optical film comprises an attachment mechanism along at least one peripheral edge.

35. The case kit of claim 33 wherein the optical film is provided in a panel and the panel comprises an attachment mechanism along at least one peripheral edge.

36. The case kit of claim 33 wherein the case and the optical film comprise cooperating attachment members.

37-42. (canceled)

43. The case kit of claim 33 wherein at least a portion of interior surfaces of the panel, pockets, or a combination thereof have has a coefficient of friction of at least 0.5.

44-49. (canceled)
